(19) United States
(12) Patent Application Publication
(10) Pub. No.: US 2025/0273661 A1
(43) Pub. Date: Aug. 28, 2025

(54) NEGATIVE ELECTRODE MATERIAL, NEGATIVE ELECTRODE PLATE AND SECONDARY BATTERY

(71) Applicant: BTR NEW MATERIAL GROUP CO., LTD., Shenzhen (CN)

(72) Inventors: Yumei YANG, Shenzhen (CN); Hang DONG, Shenzhen (CN); Tao XU, Shenzhen (CN); Haihui ZHOU, Shenzhen (CN); Peng HE, Shenzhen (CN); Jianguo REN, Shenzhen (CN); Youyuan HUANG, Shenzhen (CN); Xueqin HE, Shenzhen (CN)

(73) Assignee: BTR NEW MATERIAL GROUP CO., LTD., Shenzhen (CN)

(21) Appl. No.: 19/205,223

(22) Filed: May 12, 2025

(30) Foreign Application Priority Data
Nov. 28, 2024 (CN) 202411742138.9

(51) Int. Cl. H01M 4/36; H01M 4/02; H01M 4/583; H01M 4/60

(52) U.S. Cl. CPC H01M 4/366; H01M 4/583; H01M 4/602; H01M 2004/021; H01M 2004/027

(57) ABSTRACT

A negative electrode material, a negative electrode plate and a secondary battery are provided. The negative electrode material includes an inner core and a coating layer arranged on at least a part of a surface of the inner core, the coating layer includes a polymer, an infrared spectrum of the negative electrode material has a first characteristic peak, a second characteristic peak and a third characteristic peak in a wave number range of 1320±10 cm⁻¹ to 1880±10 cm⁻¹, a peak area ratio of the first characteristic peak to the third characteristic peak is Z, and the Z is 0.35 to 0.8.

### CROSS REFERENCE TO RELATED APPLICATION

The present application claims the priority of Chinese Patent Application No. 202411742138.9 filed on Nov. 28, 2024. The entire contents of the Chinese patent application are incorporated into the present application by reference.

### TECHNICAL FIELD

The present application relates to the field of electrochemical energy storage, and specifically relates to a negative electrode material, a negative electrode plate and a secondary battery.

### BACKGROUND

Secondary batteries (such as lithium-ion batteries) have been widely used in various fields such as electronic devices and electric vehicles, and negative electrode materials have always been one of important factors restricting electrochemical performance of the secondary batteries. Graphite materials have become mainstream negative electrode materials for commercial lithium-ion batteries because of the advantages of good conductivity, low lithium ions intercalation potential, layered structure suitable for intercalation/deintercalation of lithium ions, small volume expansion, low cost, etc. However, since existing graphite negative electrode materials have poor compatibility with electrolyte solutions, co-intercalation of electrolyte solvents and the lithium ions in a graphite layer is likely to be caused, resulting in irreversible consumption of the lithium ions and stripping of the graphite layer, thus affecting initial coulombic efficiency of the batteries.

### SUMMARY

The main purpose of the present application is to provide a negative electrode material, a negative electrode plate and a secondary battery to solve the problem of low initial coulombic efficiency of a battery.

To achieve the above purpose, the present application provides a negative electrode material, which includes an inner core and a coating layer arranged on at least a part of a surface of the inner core, the coating layer includes a polymer, an infrared spectrum of the negative electrode material has a first characteristic peak, a second characteristic peak and a third characteristic peak in a wave number range of 1320 cm⁻¹ to 1880 cm⁻¹, the first characteristic peak is a bending vibration peak of a —CH₂ bond, the second characteristic peak is a stretching vibration peak of a C—N bond, the third characteristic peak is a stretching vibration peak of a C═C bond, a peak area ratio of the first characteristic peak to the third characteristic peak is Z, and the Z is 0.35 to 0.8.

In some possible embodiments, a peak area of the second characteristic peak is 1,100 to 1,300.

In some possible embodiments, a Raman scattering spectrum of the negative electrode material has a characteristic peak D and a characteristic peak G at a wave number of 1350±10 cm⁻¹ and 1580±10 cm⁻¹, respectively, a peak area ratio of the characteristic peak D to the characteristic peak G is I_{D}/I_{G}, and the I_{D}/I_{G} is 0.02 to 0.50.

In some possible embodiments, the I_{D}/I_{G} is 0.10 to 0.48.

In some possible embodiments, a specific surface area of the negative electrode material is less than or equal to 8 m²/g.

In some possible embodiments, the specific surface area of the negative electrode material is 2 m²/g to 8 m²/g.

In some possible embodiments, a tap density of the negative electrode material is greater than or equal to 0.75 g/cc.

In some possible embodiments, a median particle size Dᵥ50 of the negative electrode material is 1 μm to 35 μm.

In some possible embodiments, a thickness of the coating layer is 1 nm to 100 nm.

In some possible embodiments, the inner core includes graphite, and the graphite includes at least one of natural graphite and artificial graphite.

In some possible embodiments, a median particle size Dᵥ50 of particles of the graphite is 1 μm to 30 μm.

The present application also provides a negative electrode plate, which includes a negative current collector and a negative active material layer arranged on the negative current collector, wherein the negative active material layer includes the above negative electrode material.

The present application also provides a secondary battery, which includes the above negative electrode material or negative electrode plate.

In the present application, the Z value of the negative electrode material meets the preset range, and the stretching vibration peak of the C—N bond exists, so that convenience is provided for a polymer monomer to form a polymer coating material with a moderate polymerization degree and fully coat the surface of the inner core. In a lithium ions intercalation process, the polymer in the coating layer preferentially undergoes a reduction reaction with an electrolyte solution component, and the C—N bond is broken and further forms compound Li₃N, that is, the coating layer is capable of being converted into a protective layer containing both the polymer and the inorganic compound Li₃N during the lithium ions intercalation. The above protective layer allows ions to pass through while hindering electrons from passing through in a lithium ions intercalation/deintercalation process, so that convenience is provided for reducing the occurrence of side reactions at an interface, reducing the consumption of lithium ions and improving the initial coulombic efficiency of the negative electrode material and the secondary battery using the same. Meanwhile, the existence of Li₃N can also improve the ionic conductivity of the polymer coating layer, so that convenience is provided for improving the dynamic performance of the negative electrode material and further improving the capacity utilization and the initial coulombic efficiency of the secondary battery using the negative electrode material.

When the Z value of the negative electrode material meets the preset range and the stretching vibration peak of the C—N bond exists, the polymer monomer provides functional groups such as an unsaturated bond like a carbon-carbon double bond and a carbon-carbon triple bond, and a carboxyl group, the unsaturated bond undergoes a self-polymerization reaction to form a polymer network, and the carboxyl group and other functional groups are capable of undergoing a dehydration reaction with a hydroxy group and other groups on a surface of the graphite to form chemical bonds to establish a chemical bridge between the coating layer and the inner core, thereby facilitating the improvement of a bonding force between the polymer network and the graphite and effectively avoiding the phenomena of falling and stripping in a charge and discharge process, thus improving the initial coulombic efficiency and the cycle performance.

### BRIEF DESCRIPTION OF THE DRAWINGS

FIG. 1 is a structural schematic diagram of a secondary battery provided in an embodiment of the present application during charge.

FIG. 2 is a structural schematic diagram of a secondary battery provided in an embodiment of the present application during discharge.

FIG. 3 is an infrared spectrum test result diagram of a negative electrode material provided in Example 1 of the present application.

FIG. 4 is a Raman spectrum test result diagram of the negative electrode material provided in Example 1 of the present application.

FIG. 5 is a TEM image of the negative electrode material provided in Example 1 of the present application.

FIG. 6 is a TEM image of the negative electrode material provided in Example 1 of the present application at a magnification.

### DESCRIPTION OF MAIN COMPONENT SYMBOLS

electrode assembly: 100
positive electrode plate: 101
negative electrode plate: 102
isolating membrane: 103

### DETAILED DESCRIPTION OF EMBODIMENTS

Examples of the present application are described in detail below. The examples described below with reference to the drawings are illustrative, which are intended only to interpret the present application and shall not be construed as limitations to the present application. It should be noted that, unless otherwise defined, all technical and scientific terms used herein have the same meanings as generally understood by those skilled in the technical field to which the present application belongs. The embodiments and features in the embodiments of the present application can be combined with each other without conflict. Many specific details are set forth in the description below to facilitate a full understanding of the present application, and the embodiments described are only a part of the embodiments of the present application, rather than all of the embodiments.

Coating on a surface of graphite can usually decrease the specific surface area and surface defects of a graphite material, improve the interface stability of the material and reduce the occurrence of side reactions on the surface of the material, thereby improving the electrochemical performance of the graphite material. However, in existing negative electrode materials, coating layers and graphite surfaces are not firmly bound, and side reactions and other problems at an interface cannot be well suppressed. Based on this, the present application provides an improved preparation process for a negative electrode material, wherein an inner core and a coating layer of the negative electrode material are firmly bound, thereby achieving the purpose of better improving the electrochemical performance of the graphite material.

Based on this, an embodiment of the present application provides a secondary battery, which includes a shell, an electrode assembly and an electrolyte. The electrode assembly and the electrolyte are both located in the shell.

The shell may be a packaging bag that is obtained by encapsulation with an encapsulation film (e.g., an aluminum-plastic film), for example, a pouch battery. In other examples, the secondary battery may also be a steel shell battery, an aluminum shell battery, etc.

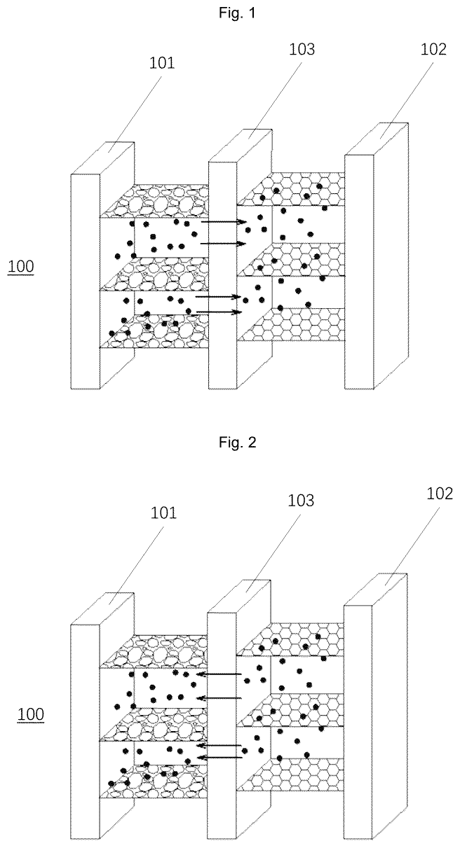

Referring to FIG. 1 and FIG. 2, the electrode assembly 100 includes a positive electrode plate 101, a negative electrode plate 102 and a isolating membrane 103, and the isolating membrane 103 is arranged between the positive electrode plate 101 and the negative electrode plate 102. When the electrolyte solution is arranged (not shown in the drawings), during charge, referring to FIG. 1, active ions (e.g., lithium ions) are removed from lattices of a positive electrode material (e.g., a lithiated intercalation compound) of the positive electrode plate 101, pass through the diaphragm 103 through the electrolyte solution to reach the negative electrode plate 102, and then are inserted into lattices of a negative electrode material. During discharge, referring to FIG. 2, the active ions (e.g., lithium ions) are removed from the lattices of the negative electrode material of the negative electrode plate 102, pass through the isolating membrane 103 through the electrolyte solution to reach the positive electrode plate 101, and then are inserted into the lattices of the positive electrode material (e.g., a lithiated intercalation compound). Generated electrons reach the positive electrode plate 101 from the negative electrode plate 102 through an external circuit, and an electric current is formed by reverse movement of the electrons and can be used by electrical appliances.

In some examples, the electrode assembly 100 may be of a laminated structure, which is formed by sequentially and alternately laminating the positive electrode plate 101, the isolating membrane 103 and the negative electrode plate 102. In other examples, the electrode assembly 100 may also be of a winding structure, which is formed by sequentially laminating and winding the positive electrode plate 101, the isolating membrane 103 and the negative electrode plate 102.

### Positive Electrode Plate

The positive electrode plate 101 includes a positive current collector and a positive active material layer arranged on at least one surface of the positive current collector. The positive current collector may use aluminum foil or nickel foil, etc., and may also be any composite current collector disclosed in the prior art, for example, but not limited to, a current collector formed by combination of the aforementioned conductive foil and a polymer substrate. The positive active material layer includes a positive active material, and the positive active material includes a compound capable of reversibly inserting and removing lithium ions (i.e., a lithiated intercalation compound). In some examples, the positive active material may include a lithium transition metal composite oxide. The lithium transition metal composite oxide contains lithium and at least one element selected from cobalt, manganese and nickel. In some examples, the positive active material may include, but is not limited to, at least one of lithium cobaltate (LiCoO₂), a lithium nickel-manganese-cobalt ternary material (NCM), lithium manganate (LiMn₂O₄), lithium nickel manganate (LiNi_{0.5}Mn_{1.5}O₄), and lithium iron phosphate (LiFePO₄).

The positive active material layer further includes a binder, which is used for bonding positive active material particles to facilitate the formation of a membrane layer and can also improve a binding force between the positive active material layer and the positive current collector. In some examples, the binder may include, but is not limited to, at least one of polyvinyl alcohol, hydroxypropyl cellulose, diacetyl cellulose, polyvinyl chloride, carboxylated polyvinyl chloride, polyvinyl fluoride, ethyleneoxy-containing polymers, polyvinylpyrrolidone, polyurethane, polytetrafluoroethylene, poly(1,1-vinylidene difluoride), polyethylene, polypropylene, styrene-butadiene rubber, acrylic (ester) styrene-butadiene rubber, epoxy resin, nylon, etc.

The positive active material layer may further include a conductive material, and the conductive material includes, but is not limited to, a carbon-based material, a metal-based material, a conductive polymer, or any combination thereof. In some examples, the carbon-based material may include, but is not limited to, natural graphite, artificial graphite, carbon black, acetylene black, Ketjen black, a carbon fiber, or any combination thereof. In some examples, the metal-based material may include, but is not limited to, metal powder or a metal fiber, such as copper, nickel, aluminum, or silver. In some examples, the conductive polymer may be a polyphenylene derivative.

### Negative Electrode Plate

The negative electrode plate 102 includes a negative current collector and a negative active material layer arranged on at least one surface of the negative current collector. The negative current collector may use at least one of copper foil, nickel foil, stainless steel foil, titanium foil, a carbon-based current collector, etc., and may also be any composite current collector disclosed in the prior art, for example, but not limited to, a current collector formed by combination of the aforementioned conductive foil and a polymer substrate.

The negative active material layer includes a negative electrode material, the negative electrode material includes an inner core and a coating layer arranged on at least a part of a surface of the inner core, the coating layer includes a polymer, an infrared spectrum of the negative electrode material has a first characteristic peak, a second characteristic peak and a third characteristic peak in a wave number range of 1320 cm⁻¹ to 1880 cm⁻¹, the first characteristic peak is a bending vibration peak of a —CH₂ bond, the second characteristic peak is a stretching vibration peak of a C—N bond, the third characteristic peak is a stretching vibration peak of a C═C bond, a peak area ratio of the first characteristic peak to the third characteristic peak is Z, and the Z is 0.35 to 0.8.

The Z value of the negative electrode material meets the preset range, and the stretching vibration peak of the C—N bond exists, so that convenience is provided for a polymer monomer to form a polymer with a moderate polymerization degree and fully coat the surface of the inner core. In a lithium intercalation process, the polymer in the coating layer preferentially undergoes a reduction reaction with an electrolyte solution component, and the C—N bond is broken and further forms compound Li₃N, that is, the coating layer is capable of being converted into a protective layer containing both the polymer and the inorganic compound Li₃N during the lithium intercalation. The above protective layer allows ions to pass through while hindering electrons from passing through in a lithium intercalation/deintercalation process, so that convenience is provided for reducing the occurrence of side reactions at an interface, reducing the consumption of lithium ions and improving the initial coulombic efficiency of the negative electrode material and the secondary battery using the same. Meanwhile, the existence of Li₃N can also improve the ionic conductivity of the polymer coating layer, so that convenience is provided for improving the dynamic performance of the negative electrode material, that is, convenience is provided for reducing the impedance of the lithium ions during the deintercalation process, and full intercalation and deintercalation of the lithium ions are facilitated, thus improving the capacity utilization and initial coulombic efficiency of the secondary battery using the negative electrode material.

When the Z value of the anode meets the preset range and the stretching vibration peak of the C—N bond exists, the polymer monomer coating material provides functional groups such as an unsaturated bond like a carbon-carbon double bond, a carbon-carbon triple bond and a carboxyl group, the unsaturated bond undergoes a self-polymerization reaction to form a polymer network, and the carboxyl group and other functional groups are capable of undergoing a dehydration reaction with a hydroxy group and other groups on a surface of the graphite to form chemical bonds to establish a chemical bridge between the coating layer and the inner core, thereby facilitating the improvement of a bonding force between the polymer network and the graphite and effectively avoiding the phenomena of falling and stripping in a charge and discharge process, thus improving the initial coulombic efficiency and the cycle performance.

The Z may be 0.35, 0.4, 0.45, 0.46, 0.5, 0.6, 0.63, 0.65, 0.67, 0.70, 0.78, 0.8, or any value in a range consisting of any two of the above numerical values. It is understandable that when the Z value is too small, it is indicated that the content of the C═C bond in the negative electrode material is higher, meaning that the content of the polymer or the polymerization degree of the polymer in the coating material on the surface of the negative electrode material is lower, at this time, the coating layer has a poor coating effect on the inner core, and the risk of side reactions between the inner core and the electrolyte solution is increased, thereby not being conducive to the performance of the negative electrode material. When the Z value is too large, it is indicated that the content of the —CH₂ bond in the negative electrode material is higher, meaning that the excessive polymer is formed in the coating material on the surface of the negative electrode material, at this time, the excessive polymer formed is prone to accumulation which is not conducive to uniform distribution on the surface of the inner core to form the uniform coating layer, and moreover, the too thick coating layer may be formed to lead to increased interface resistance of the negative electrode material, thereby being not conducive to capacity maintenance.

In a specific example of the present application, the negative electrode material is tested by using a NICOLET iS50 Fourier infrared spectrometer, scanning is performed in a wave number range selected as 500 cm⁻¹ to 4000 cm⁻¹, and an infrared spectrogram is derived out and subjected to peak position analysis. The bending vibration peak of the —CH₂ bond exists near 1440 cm⁻¹, the stretching vibration peak of the C═C bond exists near 1635 cm⁻¹, and the peak area ratio Z is obtained by calculating peak areas.

In some examples, a peak area of the C—N bond in the infrared spectrum of the negative electrode material is 1,100 to 1,300. For example, the peak area of the C—N bond may be 1,100, 1,130, 1,134, 1,159, 1,173, 1,175, 1,178, 1,190, 1,225, 1,240, 1,247, 1,300, or any value in a range consisting of any two of the above numerical values. It is understandable that the peak area of the C—N bond in the above range indicates that the coating layer has an appropriate amount of the C—N bond, and during the lithium intercalation, the C—N bond is broken and further forms an appropriate amount of the compound Li₃N containing N and Li, thereby improving the ionic conductivity of the polymer coating layer, facilitating the improvement of dynamic performance of the coating layer, and further improving the capacity utilization and initial coulombic efficiency of the negative electrode material and the secondary battery thereof. In a specific example of the present application, the negative electrode material is tested by using a NICOLET iS50 Fourier infrared spectrometer, scanning is performed in a wave number range selected as 500 cm⁻¹ to 4000 cm⁻¹, and an infrared spectrogram is derived out and subjected to peak position analysis. The stretching vibration peak of the C—N bond exists near 1560 cm⁻¹, and the peak areas are obtained by calculation.

In some examples, a Raman scattering spectrum of the negative electrode material has a characteristic peak D and a characteristic peak G at a wave number of 1350±10 cm⁻¹ and 1580±10 cm⁻¹, respectively, a peak area ratio of the characteristic peak D to the characteristic peak G is I_{D}/I_{G}, and the I_{D}/I_{G} is 0.02 to 0.50. For example, the I_{D}/I_{G} may be 0.02, 0.09, 0.12, 0.17, 0.23, 0.24, 0.25, 0.32, 0.39, 0.45, 0.48, 0.50, or any value in a range consisting of any two of the above numerical values. Taking a graphite inner core material as an example, the I_{D}/I_{G} of a graphite product is usually greater than 1. The I_{D}/I_{G} of the negative electrode material in the above range indicates that the relatively uniform coating layer is formed on the surface of the inner core of the negative electrode material, so that surface defects of the inner core material are obviously decreased, and convenience is provided for reducing side reactions between the surface of the inner core material and the electrolyte solution, thereby improving the initial coulombic efficiency. Further, the I_{D}/I_{G} is 0.10 to 0.48. Controlling the I_{D}/I_{G} of the negative electrode material in the above range is conducive to making the negative electrode material have both high capacity and initial coulombic efficiency.

In some examples, a specific surface area of the negative electrode material is less than or equal to 8 m²/g. For example, the specific surface area of the negative electrode material may be 0.5 m²/g, 1 m²/g, 2.1 m²/g, 2.7 m²/g, 3 m²/g, 3.1 m²/g, 3.2 m²/g, 3.3 m²/g, 3.5 m²/g, 4.7 m²/g, 6.2 m²/g, 8 m²/g, or any value in a range consisting of any two of the above numerical values. It is understandable that the specific surface area of the negative electrode material affects a contact area between the negative electrode material and the electrolyte solution, and the specific surface area of the negative electrode material in the above range can decrease the amount of lithium ions consumed by forming a solid electrolyte interface (SEI) membrane during initial charge and discharge of the battery prepared from the negative electrode material, and reduce the irreversible capacity loss of the battery. Further, the specific surface area of the negative electrode material is 2 m²/g to 8 m²/g. Controlling the specific surface area of the negative electrode material in the above range can balance both the charge and discharge performance and stability of the negative electrode material.

In some examples, a tap density of the negative electrode material is greater than or equal to 0.75 g/cc. For example, the tap density of the negative electrode material may be 0.75 g/cc, 0.95 g/cc, 1.00 g/cc, 1.03 g/cc, 1.05 g/cc, 1.06 g/cc, 1.07 g/cc, 1.09 g/cc, 1.10 g/cc, 1.12 g/cc, 1.15 g/cc, or any value in a range consisting of any two of the above numerical values. Controlling the tap density in the above range is conducive to forming an internal structure with suitable tightness in the negative electrode material, thereby improving the transmission of lithium ions and the conduction of electrons, increasing the energy density of the battery, prolonging the cycle life and improving the safety performance.

In some examples, a median particle size Dᵥ50 of the negative electrode material is 1 μm to μm. For example, the median particle size Dᵥ50 of the negative electrode material may be 1 μm, μm, 10 μm, 15 μm, 18 μm, 18.2 μm, 18.3 μm, 18.4 μm, 18.5 μm, 18.6 μm, 19 μm, 25 μm, 30 μm, 35 μm, or any value in a range consisting of any two of the above numerical values. The Dᵥ50 refers to a corresponding particle size value when the percentage of cumulative distribution by volume reaches 50%. Controlling the median particle size of the negative electrode material in the above range is conducive to improving the energy density, rate performance and cycle performance of the negative electrode material.

In some examples, a thickness of the coating layer is 1 nm to 100 nm. For example, the thickness of the coating layer may be 1 nm, 3 nm, 6 nm, 10 nm, 15 nm, 20 nm, 40 nm, 70 nm, 100 nm, or any value in a range consisting of any two of the above numerical values. Controlling the thickness of the coating layer of the negative electrode material in the above range is conducive to forming adequate coverage on the surface of the inner core of the negative electrode material while maintaining good interface resistance and capacity. In some examples, the coating layer may be a single-layer coating layer formed by a single material, may also be a coating layer formed by combination of multiple materials, may also be a multi-layer coating layer formed by a single material, and may also be a multi-layer coating layer formed by multiple materials, etc. A layered structure of the coating layer can be selected according to actual needs.

In some examples, the inner core includes graphite, and the graphite includes at least one of natural graphite and artificial graphite. In some examples, a median particle size Dᵥ50 of particles of the graphite is 1 μm to 30 μm. For example, the median particle size Dᵥ50 of the graphite particles may be 1 μm, 3 μm, 8 μm, 10 μm, 15 μm, 20 μm, 25 μm, 30 μm, or any value in a range consisting of any two of the above numerical values. The natural graphite and the artificial graphite are low in cost and easy to produce in a large scale. Controlling the particle size in the above range is conducive to balancing the processing performance and electrochemical performance of the negative electrode material.

The negative active material layer further includes a binder that is used for bonding negative active material particles to facilitate the formation of a membrane layer and can also improve a binding force between the negative active material layer and the negative current collector. In some examples, the binder may include, but is not limited to, polyvinyl alcohol, hydroxypropyl cellulose, diacetyl cellulose, polyvinyl chloride, carboxylated polyvinyl chloride, polyvinyl fluoride, ethyleneoxy-containing polymers, polyvinylpyrrolidone, polyurethane, polytetrafluoroethylene, poly(1,1-vinylidene difluoride), polyethylene, polypropylene, styrene-butadiene rubber, acrylic (ester) styrene-butadiene rubber, epoxy resin, nylon, etc.

The negative active material layer may further include a conductive material, and the conductive material includes, but is not limited to, a carbon-based material, a metal-based material, a conductive polymer, or any combination thereof. In some examples, the carbon-based material may include, but is not limited to, natural graphite, artificial graphite, carbon black, acetylene black, Ketjen black, a carbon fiber, or any combination thereof. In some examples, the metal-based material may include, but is not limited to, metal powder or a metal fiber, such as copper, nickel, aluminum, or silver. In some examples, the conductive polymer may be a polyphenylene derivative.

### Isolating Membrane

The isolating membrane 103 includes a membrane layer with a porous structure, and a material of which includes, but is not limited to, at least one of polyethylene, polypropylene, polyvinylidene fluoride, polyethylene glycol terephthalate, polyimide, or aramid. For example, the isolating membrane 103 may be a polypropylene porous membrane, a polyethylene porous membrane, a polypropylene non-woven fabric, a polyethylene non-woven fabric, or a polypropylene-polyethylene-polypropylene porous composite membrane, etc.

### Electrolyte

The electrolyte has the effect of conducting ions between the positive electrode plate 101 and the negative electrode plate 102. The electrolyte may have one or more states of a gel state, a solid state, and a liquid state. In some examples, the electrolyte adopts an electrolyte solution. The electrolyte solution has the effect of conducting active ions between the positive electrode plate 101 and the negative electrode plate 102. In some examples, the electrolyte solution includes a lithium salt and an organic solvent. The lithium salt may be selected from, but is not limited to, one or more of lithium hexafluorophosphate (LiPF₆), lithium tetrafluoroborate (LiBF₄), lithium hexafluoroarsenate (LiAsF₆), lithium perchlorate (LiClO₄), lithium tetraphenylborate (LiB(C₆H₅)₄), lithium methanesulfonate (LiCH₃SO₃), lithium bis(fluorosulfonyl)imide (LiFSI), lithium bis(trifluoromethanesulfonyl)imide (LiTFSI), lithium trifluoromethanesulfonate (LiCF₃SO₃), lithium bis(trifluoromethylsulfonyl)imide (LiN(SO₂CF₃)₂), lithium tri(trifluoromethylsulfonyl)methide (LiC(SO₂CF₃)₃), lithium bis(oxalate)borate (LiBOB), and lithium difluorophosphate (LiPO₂F₂). For example, LiPF₆ is selected as the lithium salt, because it can provide high ionic conductivity and improve cycle characteristics. The organic solvent may be a carbonate compound, a carboxylic ester compound, an ether compound, a nitrile compound, another organic solvent, or a combination thereof. Examples of the carbonate compound include, but are not limited to, diethyl carbonate (DEC), dimethyl carbonate (DMC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), vinylethylene carbonate (VEC), fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

Another embodiment of the present application further provides a method for preparing the negative electrode material, which includes the following.

Step 1: A polymer monomer, graphite, an oxidation environment regulator and water are mixed to obtain a mixed solution, wherein the polymer monomer has at least one of an unsaturated double bond, a carboxyl group and a hydroxy group, a mass ratio of the polymer monomer to the graphite is (1%-20%):1, a mass ratio of the oxidation environment regulator to the graphite is (0.1%-10%):1, a pH value is adjusted to 2 to 12, and a solid-liquid ratio of the mixed solution is 1:(1.5−5).

The polymer monomer has highly reactive active sites and is converted into cationic free radicals in a specific solution environment when being used as a coating material, the adjacent cationic free radicals form a dimer by a head-tail connection method, the dimer continuously grows to form a polymer with a higher polymerization degree, and the polymer is distributed on a graphite particle to form a surface coating layer by preferentially undergoing reactions such as dehydration and condensation with active sites such as a hydroxy group on an end face of the graphite (inner core material).

The mass ratio of the polymer monomer to the graphite may be 1%:1, 2%:1, 3%:1, 5%:1, 8%:1, 10%:1, 12%:1, 15%:1, 17%:1, 20%:1, or any value in a range consisting of any two of the above numerical values. Controlling the mass ratio of the polymer monomer to the graphite in the above range is conducive to forming the even coating layer on the surface of the inner core of the negative electrode material while maintaining good interface resistance and capacity. The pH value may be adjusted to 2, 3, 4, 5, 6, 7, 8, 9, 10, 11, 12, or any value in a range consisting of any two of the above numerical values. The solid-liquid ratio of the mixed solution may be 1:1.5, 1:2, 1:2.5, 1:3, 1:3.5, 1:4, 1:4.5, 1:5, or any value in a range consisting of any two of the above numerical values. Controlling the pH value in the above range is conducive to promoting a polymerization reaction of the polymer monomer. The pH value may be further preferably 3 to 12, so that convenience is provided for controlling the content of a formed C—N bond and further improving the performance of the negative electrode material. Controlling the solid-liquid ratio of the mixed solution in the above range can regulate the concentration of the polymer monomer in the reaction system, thereby being conducive to regulating the reaction rate of the polymer monomer, controlling the polymer monomer to be prone to undergoing self-polymerization rather than directly depositing on the surface of the inner core material, and reducing the risks of increased specific surface area and decreased initial coulombic efficiency of the negative electrode material caused by direct deposition of the polymer monomer. The ratio of the oxidation environment regulator to the graphite may be 0.1%:1, 0.5%:1, 1%:1, 2%:1, 4%:1, 6%:1, 8%:1, 10%:1, or any value in a range consisting of any two of the above two numerical values. Controlling the oxidation environment regulator in the above range is conducive to promoting the polymerization reaction of the polymer monomer.

In some examples, the polymer monomer includes one or more of acrylamide, methylacrylamide, ethylacrylamide, phenylacrylamide, p-methylbenzamide, diamine maleate, sulfamic acid, and ammonium benzoate. The polymer prepared from the above polymer monomer can form a network structure with good ionic conductivity on the surface of the graphite, and can reduce direct contact between the electrolyte solution and the graphite, thereby improving the electrochemical performance of the negative electrode material.

In some examples, the pH value may be adjusted using an acidic or alkaline chemical product. For example, the acidic chemical product used may be one or more of hydrochloric acid, sulfuric acid, phosphoric acid, nitric acid, and acetic acid, and the alkaline chemical product may be one or more of lithium hydroxide, sodium hydroxide, potassium hydroxide, sodium carbonate, sodium bicarbonate, and ammonia water.

In some examples, the oxidation environmental regulator includes one or more of azodiisobutyronitrile, azobisisoheptonitrile, hydrogen peroxide, ammonium persulfate, sodium persulfate, potassium persulfate, aluminum chloride, and ferric chloride.

Step 2: The obtained mixed solution is heated to undergo a reaction and dried to volatilize a solvent to obtain an intermediate product.

In some examples, a temperature of the reaction is 1° C. to 90° C. For example, the temperature of the reaction may be 1° C., 5° C., 10° C., 20° C., 30° C., 40° C., 60° C., 80° C., 90° C., or any value in a range consisting of any two of the above numerical values. In some examples, a time of the reaction is 1 h to 10 h. For example, the time of the reaction may be 1 h, 2 h, 3 h, 4 h, 6 h, 8 h, 10 h, or any value in a range consisting of any two of the above numerical values. It is understandable that controlling the temperature and time of the reaction in the above ranges is conducive to self-polymerization of the polymer monomer to form a polymer coating material on the surface of the inner core material.

Step 3: The obtained intermediate product is subjected to drying at a drying temperature of 50° C. to 300° C. to obtain the negative electrode material.

For example, the drying temperature may be 50° C., 100° C., 150° C., 200° C., 250° C., 300° C., or any value in a range consisting of any two of the above numerical values. Controlling the drying temperature in the above range is conducive to maintaining the structure of the polymer, thereby facilitating the formation of a good coating on the surface of the inner core.

In some examples, a drying treatment method includes one or a combination of more of methods of blast drying, vacuum drying, freeze drying, and spray drying.

The polymer monomer used in the preparation method of the present application is a coating material. Through liquid phase coating, the polymer monomer is subjected to in-situ polymerization at a certain temperature to form the dense polymer coating material on the surface of the inner core material. The method has the characteristics of being simple in synthesis process, high in practicality and suitable for raw materials with different particle sizes.

Solutions of the present application are explained below in conjunction with examples. Those skilled in the art will understand that the examples described below are intended only to explain the present application and shall not be understood as limitations of the present application. Unless otherwise stated, reagents, software and instruments involved in the following examples, which are not specifically stated, are conventional commercially available products or open sources.

### EXAMPLE 1

A method for preparing a negative electrode material includes the following.
S1. 25 g of methylacrylamide, 500 g of graphite and 1,000 mL of deionized water were mixed and fully stirred, and then a 4 wt % sodium hydroxide solution was added drop by drop to adjust the pH value to 7 to form a mixed solution.
S2. The obtained mixed solution was heated and stirred under the condition of a water bath at 60° C. for 2 h, and then continuously stirred under the condition of a water bath at 90° C. until a liquid was completely volatilized to obtain an intermediate product.
S3. The obtained intermediate product was placed in a blast drying oven for treatment at 130° C. for 24 h, and then placed in a vacuum drying oven for treatment at 130° C. for 12 h to obtain the negative electrode material.

### EXAMPLE 2

Different from Example 1, in the S1, the dosage of the methylacrylamide was adjusted to 5 g.

### EXAMPLE 3

Different from Example 1, in the S1, the dosage of the methylacrylamide was adjusted to 100 g.

### EXAMPLE 4

Different from Example 1, in the S1, the dosage of the deionized water was adjusted to 1,500 mL.

### EXAMPLE 5

Different from Example 1, in the S1, the dosage of the deionized water was adjusted to 2,500 mL.

### EXAMPLE 6

Different from Example 1, in the S2, the time of heating and stirring under the condition of the water bath at 60° C. was adjusted to 4 h.

### EXAMPLE 7

Different from Example 1, in the S2, the temperature of heating and stirring for 2 h under the condition of the water bath was adjusted to 80° C.

### EXAMPLE 8

Different from Example 1, in the S2, the temperature of heating and stirring for 2 h under the condition of the water bath was adjusted to 40° C.

### EXAMPLE 9

Different from Example 1, in the S1, a 4 wt % HCl solution was added drop by drop to adjust the pH value to 3.

### EXAMPLE 10

Different from Example 1, in the S1, the pH value was adjusted to 12.

### EXAMPLE 11

Different from Example 1, in the S3, the treatment temperature of the blast drying oven was adjusted to 110° C., and the treatment temperature of the vacuum drying oven was adjusted to 110° C.

### EXAMPLE 12

Different from Example 1, in the S3, the treatment temperature of the blast drying oven was adjusted to 200° C., and the treatment temperature of the vacuum drying oven was adjusted to 200° C.

### EXAMPLE 13

Different from Example 1, in the S1, a 4 wt % HCl solution was added drop by drop to adjust the pH value to 2.

### EXAMPLE 14

Different from Example 1, in the S1, the dosage of the methylacrylamide was adjusted to 110 g.

### EXAMPLE 15

Different from Example 1, in the S2, the temperature of stirring for 2 h under the condition of the water bath was adjusted to 10° C.

### EXAMPLE 16

Different from Example 1, in the S2, the time of heating and stirring under the condition of the water bath at 60° C. was adjusted to 5 h.

### COMPARATIVE EXAMPLE 1

Different from Example 1, in the S1, the methylacrylamide was eliminated.

### COMPARATIVE EXAMPLE 2

Different from Example 1, in the S1, the dosage of the methylacrylamide was adjusted to 2.5 g.

### COMPARATIVE EXAMPLE 3

Different from Example 1, in the S1, the dosage of the deionized water was adjusted to 500 mL.

### COMPARATIVE EXAMPLE 4

Different from Example 1, the time of heating and stirring under the condition of the water bath at 60° C. was adjusted to 0.5 h.

### COMPARATIVE EXAMPLE 5

Different from Example 1, the S3 was adjusted to that the obtained intermediate product was placed in a rotary drum furnace for drying in a nitrogen atmosphere at 350° C. for 5 h.

Physical properties and electrochemical performance of the negative electrode materials obtained in Examples 1-16 and Comparative Examples 1-5 above were tested. Test methods are as follows.

Morphology test of the negative electrode materials: The morphology of the negative electrode materials was tested by a transmission electron microscope. A sample was loaded onto a sample table of the transmission electron microscope, and appropriate particles were selected to obtain clear images at different scales by adjusting parameters, such as magnification and focal distance, of the electron microscope.

Thickness test of a coating layer: 5 particles in a transmission electron microscope image were randomly selected, thicknesses of each particle at 10 sites were measured, and a mean was calculated to obtain the thickness of the coating layer.

Particle size test method of the negative electrode materials and graphite: The particle size distribution range of the negative electrode materials was tested by a Malvern 3000 laser particle size analyzer. A dispersant (ethanol, pure water and low-foam surfactant) and a test sample were placed in a 50 mL beaker, and a certain amount of pure water was added and fully stirred with a glass rod to make the sample evenly dispersed. A particle size test was carried out at an equipment pump rotation speed set at 2,400 r/min-2,500 r/min and a frequency at 19.5 Hz. Dᵥ50 refers to a corresponding particle size value when the percentage of cumulative distribution by volume reaches 50%. That is, particles with a particle size greater than the Dᵥ50 account for 50%, and particles with a particle size smaller than the Dᵥ50 account for 50%. The particle size Dᵥ50 of graphite is named as Dᵥ50−1, the particle size Dᵥ50 of an negative electrode material is named as Dᵥ50−2.

Specific surface area (SSA) test of the negative electrode materials: The test was carried out using GWGB DX400. A sample was loaded into a sample tube, an isothermal jacket was used on the sample tube, a filling rod was placed in a bubble tube, a clamp ring and an O-shaped ring were arranged on the bubble tube, and then the assembled sample bubble tube was placed in a corresponding analysis station for testing. At a constant low temperature, after adsorption capacities of a gas on a solid surface at different relative pressures were determined, a monolayer adsorption capacity of a sample was obtained based on a Brunauer-Emmett-Teller adsorption theory and a formula thereof (BET formula) so as to calculate the specific surface area of the sample.

Infrared spectrum test of the negative electrode materials: Functional groups on a material surface were tested by using a NICOLET iS50 Fourier infrared spectrometer. A sample was prepared into a thin sheet and placed in a sample chamber to ensure that the sample was closely fitted to a sample box, scanning was performed in a wave number range selected as 500 cm⁻¹ to 4000 cm⁻¹, 20 points were selected to perform data collection for each sample, an infrared spectrogram was derived out and subjected to peak position analysis, mapping was performed using origin software, and peak areas were calculated to obtain a mean, respectively. Peak area calculation method: First, the spectrogram was drawn using the origin software, a peak area to be calculated was selected for baseline correction, a baseline was manually adjusted, processing was performed based on an analysis-mathematics-integration function, and the peak area to be calculated was selected according to an X coordinate and then calculated automatically.

Raman I_{D}/I_{G} test of the negative electrode materials: A Raman scattering spectrum was tested using a HORIBA-XPLORA model laser confocal Raman spectrometer at a laser wavelength of 532 nm. 30 points were selected to perform data collection for each sample, respectively. The obtained scattering spectrum was subjected to peak fitting using NGSLabSpec software, wherein a D peak of the sample was near 1350 cm⁻¹, and a G peak was near 1580 cm⁻¹. After the D peak and the G peak were labeled, an area ratio of the D peak to the G peak was calculated to obtain an I_{D}/I_{G} value.

Tap density (TD) test of the negative electrode materials: A certain mass of a powder sample was placed in a measuring cylinder, the container was artificially or mechanically vibrated for 1,000 times, a volume of the sample after the vibration was read, and a ratio of the mass of the sample to the volume after the vibration was the tap density.

Electrochemical performance test: Based on the negative electrode materials prepared in examples and comparative examples of the present application, the negative electrode materials, carboxymethyl cellulose and styrene-butadiene rubber were dissolved in deionized water according to a mass ratio of 96.5:1.5:2, respectively, coated on a copper foil current collector with a solid content controlled at 50%, subjected to vacuum drying, rolling and stamping to prepare negative electrode plates, and then assembled into button batteries in a glove box filled with argon with a metallic lithium sheet as a counter electrode. A charge and discharge test was carried out at a current density of 0.1 C and a charge and discharge interval of 0.01 V to 1.5 V to obtain an initial reversible specific capacity, a first-circle charge capacity and a first-circle discharge capacity, wherein the initial coulombic efficiency (ICE)=first-circle discharge capacity/first-circle charge capacity.

Partial preparation conditions in Examples 1-16 and Comparative Examples 1-5 above refer to Table 1. The above test results refer to corresponding drawings and Table 2.

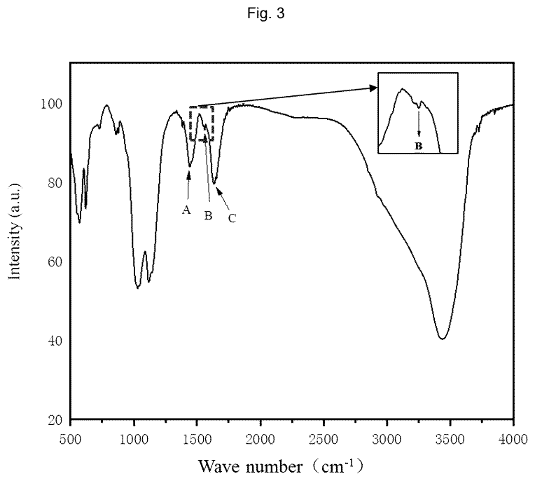

Taking Example 1 as an example, an infrared spectrum test was carried out on the negative electrode material. Referring to FIG. 3, three peaks including a bending vibration peak (near 1440 cm⁻¹), that is peak A, of a —CH₂ bond, a stretching vibration peak (near 1560 cm⁻¹), that is peak B, of a C—N bond and a stretching vibration peak (near 1635 cm⁻¹), that is peak C, of a C═C bond sequentially exist from 1320 cm⁻¹ to 1880 cm⁻¹.

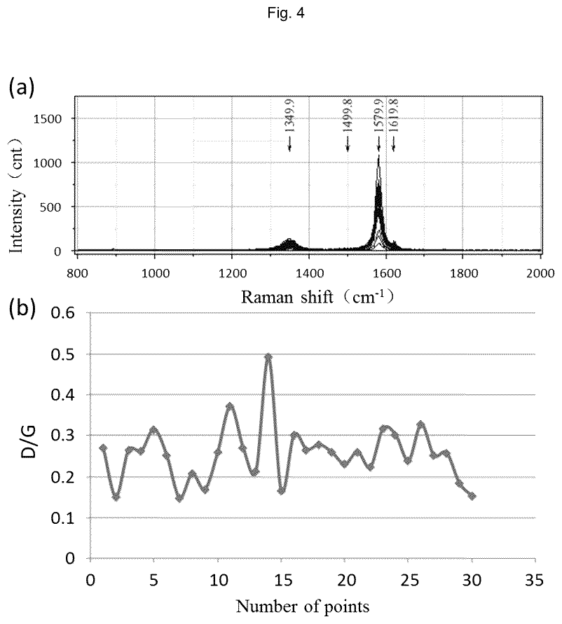

Taking Example 1 as an example, a Raman spectrum test was carried out on the negative electrode material. Referring to FIG. 4, a peak D exists at 1349.9 cm⁻¹, a peak G exists at 1579.9 cm⁻¹, and an average peak area ratio of the peak D to the peak G obtained by statistics is 0.25.

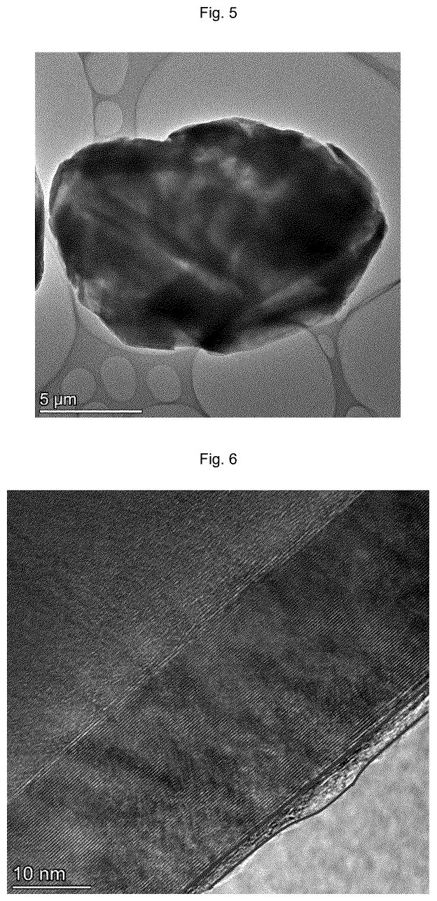

Similarly, taking Example 1 as an example, a morphology test was carried out on the negative electrode material. Referring to FIG. 5, the negative electrode material prepared in the example of the present application has spherical like morphology as a whole and no obvious agglomerates. Referring to FIG. 6, it can be seen at the magnification that an edge part of a surface of the negative electrode material is different from a layered structure of the graphite, indicating that uniform distribution of the coating material on the graphite material can be achieved by using the preparation method of the present application.

TABLE 1
Partial preparation conditions in Examples 1-16 and
Comparative Examples 1-5 of the present application

| | | Dosage | | Heating | | |
|---|---|---|---|---|---|---|
| | Dosage of | of | Heating | and | | |
| | methyl- | deionized | and | stirring | PH value | Drying |
| | acrylamide | water | stirring | temperature | of mixed | temperature |
| Example | (g) | (mL) | time (h) | (° C.) | solution | (° C.) |
| Example 1 | 25 | 1000 | 2 | 60 | 7 | 130° C. |
| Example 2 | 5 | 1000 | 2 | 60 | 7 | 130° C. |
| Example 3 | 100 | 1000 | 2 | 60 | 7 | 130° C. |
| Example 4 | 25 | 1500 | 2 | 60 | 7 | 130° C. |
| Example 5 | 25 | 2500 | 2 | 60 | 7 | 130° C. |
| Example 6 | 25 | 1000 | 4 | 60 | 7 | 130° C. |
| Example 7 | 25 | 1000 | 2 | 80 | 7 | 130° C. |
| Example 8 | 25 | 1000 | 2 | 40 | 7 | 130° C. |
| Example 9 | 25 | 1000 | 2 | 60 | 3 | 130° C. |
| Example 10 | 25 | 1000 | 2 | 60 | 12 | 130° C. |
| Example 11 | 25 | 1000 | 2 | 60 | 7 | 110° C. |
| Example 12 | 25 | 1000 | 2 | 60 | 7 | 200° C. |
| Example 13 | 25 | 1000 | 2 | 60 | 2 | 130° C. |
| Example 14 | 110 | 1000 | 2 | 60 | 7 | 130° C. |
| Example 15 | 25 | 1000 | 2 | 10 | 7 | 130° C. |
| Example 16 | 25 | 1000 | 5 | 60 | 7 | 130° C. |
| Comparative | 0 | 1000 | 2 | 60 | 7 | 130° C. |
| Example 1 | | | | | | |
| Comparative | 2.5 | 1000 | 2 | 60 | 7 | 130° C. |
| Example 2 | | | | | | |
| Comparative | 25 | 500 | 2 | 60 | 7 | 130° C. |
| Example 3 | | | | | | |
| Comparative | 25 | 1000 | 0.5 | 60 | 7 | 130° C. |
| Example 4 | | | | | | |
| Comparative | 25 | 1000 | 2 | 60 | 7 | 350° C. |
| Example 5 | | | | | | |

TABLE 2
Property test results of negative electrode materials in Examples
1-16 and Comparative Examples 1-5 of the present application

| | | | | Thickness | | | | | Initial | |
|---|---|---|---|---|---|---|---|---|---|---|
| | | | | of a | | | Stretching | | reversible | |
| | | | | coating | | | vibration | | specific | |
| | Dᵥ50-1 | Dᵥ50-2 | SSA | layer | TD | | peak area | | capacity | ICE |
| Example | (μm) | (μm) | (m²/g) | (nm) | (g/cc) | I_{D}/I_{G} | of C-N | Z | (mAh/g) | (%) |
| Example 1 | 18.00 | 18.00 | 3.50 | 2.5 | 0.85 | 0.25 | 1173 | 0.60 | 360.5 | 94.9 |
| Example 2 | 18.27 | 18.27 | 6.25 | 1.2 | 0.91 | 0.25 | 1100 | 0.46 | 358.1 | 95.0 |
| Example 3 | 18.58 | 18.60 | 2.10 | 20.0 | 0.79 | 0.17 | 1300 | 0.78 | 355.9 | 95.1 |
| Example 4 | 18.30 | 18.30 | 2.78 | 2.6 | 0.85 | 0.10 | 1130 | 0.65 | 355.1 | 94.8 |
| Example 5 | 18.17 | 18.17 | 3.16 | 2.7 | 0.85 | 0.23 | 1247 | 0.70 | 357.8 | 95.0 |
| Example 6 | 18.35 | 18.35 | 3.20 | 2.9 | 0.83 | 0.09 | 1240 | 0.63 | 357.0 | 94.8 |
| Example 7 | 18.59 | 18.59 | 3.25 | 2.6 | 0.83 | 0.12 | 1225 | 0.67 | 357.2 | 94.3 |
| Example 8 | 18.34 | 18.34 | 4.70 | 2.3 | 0.87 | 0.45 | 1134 | 0.60 | 355.7 | 94.4 |
| Example 9 | 18.20 | 18.20 | 3.34 | 2.2 | 0.86 | 0.45 | 1159 | 0.45 | 357.1 | 94.5 |
| Example 10 | 18.35 | 18.35 | 3.10 | 2.7 | 0.86 | 0.24 | 1190 | 0.50 | 357.1 | 94.5 |
| Example 11 | 18.33 | 18.33 | 3.01 | 2.6 | 0.84 | 0.48 | 1178 | 0.43 | 357.5 | 94.6 |
| Example 12 | 18.32 | 18.32 | 3.11 | 2.3 | 0.86 | 0.39 | 1175 | 0.50 | 357.3 | 94.6 |
| Example 13 | 17.86 | 17.86 | 7.52 | 1.5 | 0.89 | 1.30 | 990 | 0.35 | 354.0 | 93.8 |
| Example 14 | 18.78 | 18.80 | 2.30 | 22.0 | 0.78 | 0.17 | 1350 | 0.8 | 350.0 | 94.1 |
| Example 15 | 17.95 | 17.95 | 6.30 | 1.5 | 0.90 | 0.55 | 1150 | 0.45 | 355.6 | 93.9 |
| Example 16 | 18.30 | 18.30 | 2.80 | 3.0 | 0.83 | 0.01 | 1300 | 0.77 | 349.0 | 94.2 |
| Comparative | 17.86 | 17.86 | 8.52 | 0 | 0.93 | 1.90 | None | 0.32 | 362.8 | 93.3 |
| Example 1 | | | | | | | | | | |
| Comparative | 18.10 | 18.10 | 7.45 | 0.8 | 0.92 | 1.43 | None | 0.40 | 359.4 | 93.7 |
| Example 2 | | | | | | | | | | |
| Comparative | 17.96 | 17.96 | 5.34 | 1.2 | 0.90 | 1.59 | None | 0.85 | 353.0 | 93.2 |
| Example 3 | | | | | | | | | | |
| Comparative | 18.10 | 18.10 | 5.20 | 1.2 | 0.89 | 1.70 | 1050 | 0.31 | 354.4 | 93.5 |
| Example 4 | | | | | | | | | | |
| Comparative | 18.00 | 18.00 | 9.30 | 2.5 | 0.83 | 1.78 | None | 0.33 | 354.0 | 93.5 |
| Example 5 | | | | | | | | | | |

Under preparation process conditions of the present application, polymer coating layers are formed on surfaces of inner cores of the negative electrode materials in Examples 1-16, the coating layers have the —CH₂ bond, the C—N bond and the C═C bond, and the Z value falls within the preset range. Accordingly, during lithium ions intercalation of the negative electrode materials, the polymer coating layers preferentially undergo a reduction reaction with an electrolyte solution component, the C—N bond is broken and further forms compound Li₃N containing N and Li, and a protective layer, similar to an SEI membrane, containing both the polymer and the inorganic compound Li₃N is formed on the coating layers. During lithium ions deintercalation, ions are allowed to pass through while electrons are hindered from passing through, so that convenience is provided for reducing the occurrence of side reactions at an interface and reducing the consumption of lithium ions, thus making the obtained secondary batteries have obviously higher initial coulombic efficiency. Meanwhile, the existence of Li₃N can also improve the ionic conductivity of the polymer coating layers, thereby improving the dynamic performance of the coating layers and further improving the capacity utilization and initial coulombic efficiency of the obtained secondary batteries.

As can be seen from the preparation processes in Examples 1-3, when the mass ratio of the polymer monomer (coating material) to the graphite (inner core material) is gradually increased in a suitable range, the stretching vibration peak area of the C—N and the Z value of the obtained negative electrode materials are gradually increased. In the preparation processes in Example 1 and Examples 4-5, when the solid-liquid ratio is gradually decreased in a suitable range, the polymer monomer is more prone to self-polymerization to form a polymer coating material in the reaction system, and thus, the stretching vibration peak area of the C—N and the Z value of the obtained negative electrode materials are gradually increased. In the preparation processes in Example 1 and Example 6, when the heating reaction time is prolonged in a suitable range, the polymerization degree of the polymer is increased, the stretching vibration peak area of the C—N and the Z value of the obtained negative electrode materials are gradually increased, and the negative electrode materials all have good initial coulombic efficiency in the range. In the preparation processes in Example 13, Example 9, Example 1 and Example 10, when the pH value of the mixed solution is gradually increased, the Z value of the obtained negative electrode materials is changed in a preset range with the change of the pH condition, and the stretching vibration peak area of the C—N is also gradually increased. According to the above data, it can be seen that when the stretching vibration peak area of the C—N is 1,100-1,300, the negative electrode materials have better electrochemical performance. In the preparation processes in Example 11, Example 1 and Example 12, when the drying temperature is gradually increased in a suitable range, the polymerization degree of the polymer is decreased at a relatively high drying temperature, and thus, the stretching vibration peak area of the C—N and the Z value of the obtained negative electrode materials are gradually decreased in preset ranges.

By comparing the preparation processes and test results in Examples 1-3 and Example 14, it can be seen that the dosage of the coating material in Examples 1-3 is moderate, the stretching vibration peak area of the C—N of the obtained negative electrode materials is in the range of 1,100-1,300, and the batteries prepared from the negative electrode materials have relatively good electrochemical performance and have both good initial reversible specific capacity and initial coulombic efficiency.

By comparing the preparation processes in Example 1, Examples 6-8, Example 15 and Example 16, it can be seen that when the temperature and time of the water bath are controlled in appropriate ranges, the polymer has a better coating effect, the I_{D}/I_{G} is within 0.02-0.5, the obtained negative electrode materials have good electrochemical performance, and the batteries prepared from the negative electrode materials have higher initial reversible specific capacity and initial coulombic efficiency.

Compared with Example 1, the polymer monomer is not added in the preparation process in Comparative Example 1, the prepared negative electrode material mainly containing the graphite has no C—N bond detected on the surface, the Z value is too small, the surface of the negative electrode material is prone to undergoing side reactions with an electrolyte solution, consumption of lithium ions is intensified, and the initial coulombic efficiency is obviously lower.

Compared with Example 1, the too low dosage of the polymer monomer in the preparation process in Comparative Example 2 leads to the lower ratio of the polymer monomer to the graphite, so that the formed coating layer is insufficient, no C—N bond is detected on the surface, the Z value is too small, the coating effect is poor, and the initial coulombic efficiency is obviously lower.

It should be noted that numerical results of the capacity in Comparative Example 1 and Comparative Example 2 are higher, because the polymer coating layer itself does not have lithium storage activity, and the mass of the coating layer needs to be taken into account when the gram capacity is calculated. Therefore, in Comparative Example 1 (almost no coating layer is formed) and Comparative Example 2 (a small amount of the coating layer is formed), calculation results of the capacity are slightly higher, but it does not indicate that the performance in Comparative Example 1 and Comparative Example 2 is better than that in examples.

Compared with Example 1, the too small dosage of the water in the preparation process in Comparative Example 3 leads to the too high solid-liquid ratio, so that the concentration of the polymer monomer in the system is too high, the self-polymerization reaction of the polymer monomer is intensified, and the C═C bond is decreased. Therefore, the peak area of the C═C in the infrared spectrum is decreased, so that the Z value is too large, and no C—N bond is detected on the surface. The intensified self-polymerization reaction is likely to form excessive accumulation of the polymer coating material, which is not conducive to forming the uniform coating layer and maintaining good interface resistance, so that the initial coulombic efficiency is obviously lower.

Compared with Example 1, the heating reaction time in the preparation process in Comparative Example 4 is insufficient, so that the polymer monomer is not fully polymerized or not stably bonded to the surface of the graphite, the Z value is too small, and the coating effect is poor, that is, the stretching vibration peak area of the C—N is not too low, but the initial coulombic efficiency is still obviously lower.

Compared with Example 1, the drying temperature in the preparation process in Comparative Example 5 is too high, so that the formed polymer coating material is not evenly coated on the surface of the graphite, but undergoes a decomposition reaction, no C—N bond is detected on the surface, the Z value is too small, the polymerization degree of the polymer is decreased, and the polymer is agglomerated into a small ball, leading to obviously increased specific surface area and obviously lower initial coulombic efficiency of the negative electrode material.

In summary, by using the preparation method of the present application, the polymer monomer undergoes self-polymerization and forms the even polymer coating layer on the surface of the inner core of the negative electrode material, and the obtained negative electrode material has good electrochemical performance.

The above embodiments are used only to illustrate the technical solutions of the present application, rather than to limit the present application. Although the present application has been illustrated in detail with reference to the above preferred embodiments, those of ordinary skill in the art shall understand that modifications or equivalent substitutions of the technical solutions of the present application can be made without departing from the spirit and scope of the technical solutions of the present application.

What is claimed is:

1. A negative electrode material, comprising:
an inner core; and
a coating layer arranged on at least a part of a surface of the inner core,
wherein the coating layer comprises a polymer, an infrared spectrum of the negative electrode material has a first characteristic peak, a second characteristic peak and a third characteristic peak in a wave number range of 1320 cm⁻¹ to 1880 cm⁻¹, the first characteristic peak is a bending vibration peak of a —CH₂ bond, the second characteristic peak is a stretching vibration peak of a C—N bond, the third characteristic peak is a stretching vibration peak of a C═C bond, a peak area ratio of the first characteristic peak to the third characteristic peak is Z, and the Z is 0.35 to 0.8.

2. The negative electrode material according to claim 1, wherein a peak area of the second characteristic peak is 1,100 to 1,300.

3. The negative electrode material according to claim 1, wherein a Raman scattering spectrum of the negative electrode material has a characteristic peak D and a characteristic peak G at a wave number of 1350±10 cm⁻¹ and 1580±10 cm⁻¹, respectively, a peak area ratio of the characteristic peak D to the characteristic peak G is I_{D}/I_{G}, and the I_{D}/I_{G} is 0.02 to 0.50.

4. The negative electrode material according to claim 3, wherein the I_{D}/I_{G} is 0.10-0.48.

5. The negative electrode material according to claim 1, wherein a specific surface area of the negative electrode material is less than or equal to 8 m²/g.

6. The negative electrode material according to claim 5, wherein the specific surface area of the negative electrode material is 2 m²/g to 8 m²/g.

7. The negative electrode material according to claim 1, wherein a tap density of the negative electrode material is greater than or equal to 0.75 g/cc.

8. The negative electrode material according to claim 1, wherein a median particle size Dᵥ50 of the negative electrode material is 1 μm to 35 μm.

9. The negative electrode material according to claim 1, wherein a thickness of the coating layer is 1 nm to 100 nm.

10. The negative electrode material according to claim 1, wherein the inner core comprises graphite, and the graphite comprises at least one of natural graphite and artificial graphite.

11. The negative electrode material according to claim 10, wherein a median particle size Dᵥ50 of particles of the graphite is 1 μm to 30 μm.

12. A negative electrode plate, comprising a negative current collector and a negative active material layer arranged on the negative current collector, wherein the negative active material layer comprises the negative electrode material according to claim 1.

13. The negative electrode plate according to claim 12, wherein the negative current collector comprises at least one of copper foil, nickel foil, stainless steel foil, titanium foil, and carbon-based current collector.

14. A secondary battery, comprising the negative electrode material according to claim 1.

15. A secondary battery, comprising the negative electrode plate according to claim 12.
